(19) United States
(12) Patent Application Publication
(10) Pub. No.: US 2008/0175408 A1
(43) Pub. Date: Jul. 24, 2008

(54) PROXIMITY FILTER

(76) Inventors: Shridhar Mukund, San Jose, CA (US); Vivek Nigam, Sunnyvale, CA (US)

Correspondence Address: MARTINE PENILLA & GENCARELLA, LLP, 710 LAKEWAY DRIVE, SUITE 200, SUNNYVALE, CA, 94085, US

(21) Appl. No.: 11/757,110

(22) Filed: Jun. 1, 2007

Related U.S. Application Data
(60) Provisional application No. 60/885,882, filed on Jan. 20, 2007.

(51) Int. Cl. G10L 21/02; G10L 21/00

(52) U.S. Cl. 381/94.1; 381/94.7

(57) ABSTRACT

An audio signal enhancement device is provided. The device includes a first and a second microphone, placed as close together as possible, the first and second microphone having receiving surfaces facing in opposing directions. The first and second microphones receive a desired target audio signal originating in the proximity of the microphones and undesired noise signals not originating in the proximity of the microphones. The acoustic pressure gradient from the desired target signal between the first and the second microphones is greater than that from the noise signals. A signal processing logic is provided. The signal processing logic is configured to firstly generate a proximity-indicator signal and a pre-target-estimate signal through a combination of output from the first microphone and output of the second microphone. The signal processing logic is further configured to generate a noise-estimate signal by combining the output from the first microphone with the proximity-indicator and the pre-target-estimate. The signal processing logic is further configured to generate a target-estimate signal by combining the output from the first microphone with the proximity-indicator and the noise-estimate. The signal processing logic is further configured to provide a target signal substantially free from noise by combining the target-estimate, noise-estimate and the proximity-indicator.

### CLAIM OF PRIORITY

The present application claims priority under 35 U.S.C. § 119(e) from U.S. Provisional Patent Application No. 60/885,882, filed Jan. 20, 2007. The present application is related to U.S. application Ser. No. 11/426,887 entitled APPARATUS FOR PERFORMING COMPUTATIONAL TRANSFORMATIONS AS APPLIED TO IN-MEMORY PROCESSING OF STATEFUL, TRANSACTION ORIENTED SYSTEMS, U.S. application Ser. No. 11/426,882 entitled METHOD FOR SPECIFYING STATEFUL, TRANSACTION-ORIENTED SYSTEMS FOR FLEXIBLE MAPPING TO STRUCTURALLY CONFIGURABLE, IN-MEMORY PROCESSING SEMICONDUCTOR DEVICE, and U.S. application Ser. No. 11/426,880 entitled STRUCTURALLY FIELD-CONFIGURABLE SEMICONDUCTOR ARRAY FOR IN-MEMORY PROCESSING OF STATEFUL, TRANSACTION-ORIENTED SYSTEMS, each of which are incorporated by reference in their entirety for all purposes.

### BACKGROUND

The present invention generally describes a device that assists in speech communication. Particularly, it describes a unique placement of sensors and a set of techniques that suppress noise in an audio signal and hence could be readily used with a multitude of devices including mobile phones, laptops, video games console, headsets and automobile command console, etc.

In many applications, a speech signal is received by one of the above mentioned devices, in the presence of ambient noise, and is either transmitted to a user on the other side (in case of cell phones, headsets, etc.) or translated to a set of actions (command consoles). The noise corrupted speech signal is captured by either a single microphone (cell phones) or multiple microphones (car command console).

The presence of noise in the primary speech degrades its intelligibility, with the degradation being proportional to the noise energy. In cell phones, a person conversing in a noisy environment, like a crowded cafe or a busy train station, might not be able to converse properly as the noise corrupted speech perceived by the user on the other side is less intelligible. Similarly, a set of commands, delivered to a voice command console in an automobile, might not translate into proper actions, due to the presence of strong wind noise, or other environmental noises. In all such cases of speech corruption, a way of improving the quality of transmitted speech, by suppressing the interrupting noise, is desirable.

The problem of noise suppression has been addressed in a variety of manners, although these techniques do not provide a generic satisfactory solution for the small form consumer devices. Adaptive noise cancellation (ANC), which utilizes multiple microphones, was one attempt to improve capturing a signal in a noisy environment. One of the microphones, called the primary microphone, receives the primary speech signal that is corrupted by several noise sources. The remaining microphones provide noise references, relatively free of primary speech, which are assumed to be correlated with noise sources corrupting the primary microphone. This method gives good noise suppression as long as good noise references are available. However, in applications where the noise reference is not available, the method fails to perform satisfactorily. Furthermore, under ANC, providing a clean noise reference is usually a problem in devices that have a small form factor.

Another method proposed to suppress noise in primary speech utilizes an array of microphones. The array forms a beam towards the target of primary speech thus capturing most of the speech energy and rejecting any energy that comes from outside the beam. However, satisfactory performance is obtained only when the array is large in dimension and operates in an essentially reverberation-less environment. Also, the noise energy that falls in the speech beam is difficult to suppress. The method is difficult to implement in communication devices due to their small form factor that limits the placement of microphones on the devices.

Another widely used method to suppress noise in primary speech utilizes the method of spectral subtraction (SS). SS utilizes a voice activity detector (VAD) that identifies voice segments in speech and subtracts from it the spectrum of noise estimated from the non-voice (quiet) segments of the microphone output. However, VAD might not identify primary speech in the presence of strong speech-like noise sources, like the restaurant babble of people talking in the background. Moreover, SS is mostly successful when the speech is corrupted by stationary noise. SS performance is poor in the presence of rapidly changing non-stationary noise that defines the majority of practical noise scenarios.

Recently, methods utilizing statistical independence of speech and noise sources have been proposed to separate noise from speech. These methods, commonly called blind source separation (BSS) techniques, require as many sensors as the number of sound sources involved (sensor constraint). However, BSS algorithms perform poorly in realistic environments, where sensor constraint is not satisfied and where reverberations are dominant, which are conditions encountered in almost all noisy environments. Thus, BSS techniques are not an optimal solution for small form factor devices. Based on these observations, there is a need for suppressing noise in an audio signal that is captured in a noisy environment.

### SUMMARY

This invention provides an audio signal enhancement device. The device includes a first and a second microphone, placed as close together as possible in one embodiment. The first and second microphones have receiving surfaces facing in opposing or different directions. The first and second microphones receive a desired target audio signal originating in the proximity of the microphones and undesired noise signals not originating in the proximity of the microphones. In one embodiment, the audio signal enhancement device is incorporated into a small form factor device, such as a cell phone.

In the embodiments described below, the acoustic pressure gradient is captured and utilized to enhance an audio signal referred to as a target signal. The acoustic pressure gradient from the desired target signal between the first and the second microphones is greater than that from the noise signals. Signal processing logic is included and is configured to generate a proximity-indicator signal and a pre-target-estimate signal by combining output from the first microphone and output of the second microphone. The signal processing logic is further configured to generate a noise-estimate signal by combining the output from the first microphone with the proximity-indicator and the pre-target-estimate. The signal processing logic is further configured to generate a target-estimate signal by combining the output from the first microphone with the proximity-indicator and the noise-estimate. The signal processing logic is further configured to provide a target signal substantially free from noise by combining the target-estimate, noise-estimate and the proximity-indicator.

With more and more cell phones providing web services, cell phone users are taking up to browsing the Internet, reading text messages and watching videos on their cell phones besides giving speech commands to them to perform specific actions (like dialing a friend by calling his name or requesting a song by humming the song). These applications require the cell phone to be away from the human speaker while still capable of receiving the speech. This mode may be referred to as the video telephony (VT) mode. An embodiment of the proposed invention is capable of suppressing noise in speech in VT applications. In one embodiment, the device proposed in this invention utilizes two microphones in the back to back configuration and hence has a small factor. This facilitates the usage of the signal enhancement circuitry in mobile phones, laptops and video game consoles.

In one embodiment of the invention, an effective method to perform echo cancellation is provided. Echo is generated when speech emanating from the speakers of the cell phone is coupled with audio captured by the microphones and propagated back to the user on the other end. Echo is a problem in VT mode when the cell-phone speakers are operating at a relatively high volume. Echo not only is annoying, but also degrades the intelligibility of speech.

Other aspects and advantages of the invention will become apparent from the following detailed description, taken in conjunction with the accompanying drawings, illustrating by way of example the principles of the invention.

### BRIEF DESCRIPTION OF THE DRAWINGS

Aspects of the present invention will become apparent from the following detailed description, taken in conjunction with the accompanying drawings, illustrating by way of example the principles of the invention.

FIG. 1A is a simplified schematic diagram illustrating a possible placement of microphones where the receiving surfaces of the two microphones make an angle that is other than zero in accordance with one embodiment of the invention.

FIG. 1B is a simplified schematic diagram illustrating the placement of the first and the second microphones of the proximity filter in accordance with one embodiment of the invention.

FIGS. 1C and 1D illustrate the concepts of near-field, far-field, and proximity-field in accordance with one embodiment of the invention.

FIG. 2A is a simplified schematic diagram illustrating a mobile phone having microphones in back to back configuration for enhancing audio signals of a phone conversation in the proximity-field of the target speaker in accordance with one embodiment of the invention.

FIG. 2B is a simplified schematic diagram of a laptop having microphones in back to back configuration in accordance with one embodiment of the invention.

FIG. 2C is simplified schematic diagram of a wireless headset having microphones in back to back configuration in the proximity-field of the target speaker in accordance with one embodiment of the invention.

FIG. 2D is a simplified schematic diagram illustrating a side view of the wireless headset of FIG. 2C.

FIG. 3A is a block diagram of the components of the proximity filter capable of suppressing noise from an audio signal of interest in accordance with one embodiment of the invention.

FIG. 3B is a flow chart diagram illustrating the method operations for proximity filtering to provide a relatively noise-free and enhanced signal from an audio source within a noisy environment in accordance with one embodiment of the invention.

FIG. 3C is a flow chart diagram illustrating further details of the balanced differential subtraction in accordance with one embodiment of the invention.

FIG. 4A is a simplified schematic diagram illustrating the noise-estimating adaptive filter in accordance with one embodiment of the invention.

FIG. 4B is a simplified schematic diagram illustrating the target-estimating adaptive filter in accordance with one embodiment of the invention.

FIG. 4C is a simplified schematic diagram of the post-processing block in FIG. 3A in accordance with one embodiment of the invention.

FIG. 5A is a simplified schematic diagram of a proximity filter having a cylindrical shape in accordance with one embodiment of the invention

FIG. 5B is a simplified schematic diagram of multiple proximity filters where pairs of microphones are diametrically opposed to each other in accordance with one embodiment of the invention.

FIGS. 6A-6C illustrate proximity filter configurations including equidistant loud speaker placement in accordance with one embodiment of the invention.

FIG. 7 is a simplified schematic diagram illustrating the data flow path that uses plurality of pairs of the first and the second microphones in accordance with one embodiment of the invention.

### DETAILED DESCRIPTION

An invention is described for a proximity filter that functions to suppress noise in an audio signal. It will be obvious, however, to one skilled in the art, that the present invention may be practiced without some or all of these specific details. In other instances, well known process operations have not been described in detail in order not to unnecessarily obscure the present invention.

Any sound originating from a point source in space radiates from the point in a spherical pattern. The wave of acoustic energy originating at this point moves outward in a spherical wavefront, whose size increases with time. The intensity of sound decreases as the wavefront moves farther from the point source. This decrease is proportional to the square of the radius of the sphere. The region very close to the sound source is called the “near-field” of the sound source and in this region a spherical propagating wavefront appears spherical to the sound capturing microphone. However, as one moves away from the sound source, the wavefront becomes larger in radius and appears planar to a sound capturing microphone. This region is called the “far-field” of the sound source. This region extends in space beyond a radius of |R|>2D²/λ where D is the diameter of the smallest sphere that can enclose all the sound sources and λ is the wavelength of the sound source. For a sound wave of frequency 1 KHz this radius is approximately 54 cm beyond the sound source in space, where the value of D is assumed to be 30 cm. For |R|<2D²/λ, the near-field of the source is experienced. For extended sound sources, like the mouth of a speaker, there is a region relatively close to the sound source that experiences a turbulent pressure behavior. This region is analogous to that in immediate proximity of a pebble hitting still water where water movement is turbulent, but at a farther distance gives rise to more regular spherical energy waves. This region is referred to as the “proximity-field” of the source. The size of the proximity-field is generally a function of the size of the extended sound source and for human speakers, extends to a distance several tens of centimeters from the mouth. An increase in the size of the proximity field leads to the shrinkage of the near-field and for very large sound sources, the near-field might disappear by virtue of the sound capturing device being far off from the emitting source.

The acoustic pressure gradient, which is the pressure level difference between two points in space, is largest if these points are located in the “proximity-field” and decreases as one move from the “near-field” to the “far-field”. Noise canceling microphones make use of a large pressure gradient when placed in the “proximity-field” of a sound source. The pressure difference due to the speaker between the front and the rear ports of a noise canceling microphone is large, giving rise to a significant resultant target signal. However, noise sources that are located in the “far-field” of the noise canceling microphones have very small pressure gradients across their ports, giving rise to a very weak resultant noise signal and hence, a weaker impact on the signal of interest being captured by the microphones.

The embodiments described below describe a method and apparatus for providing a clean audio signal generated from a relatively close by signal source in a noisy environment. Microphone pairs, either in a single configuration or in an array, are placed back to back, or facing in different directions, on a suitable device to be operated in the proximity-field of a target speaker. The microphone pairs receive a noise corrupted target signal, and the proximity filter amplifies one of the outputs of the microphones and subtracts this result from the output of the second microphone to yield a pre-target estimate. A proximity indicator is then created to control further signal enhancement. The pre-target estimate signal and the output from the second microphone of the microphone pair, along with the proximity indicator, are combined to generate a noise estimate. This noise estimate is then combined with the output of the first microphone and the proximity indicator to obtain a target-estimate substantially free from noise. The target-estimate is further processed along with the noise-estimate to yield a clear target estimate as described in more detail below.

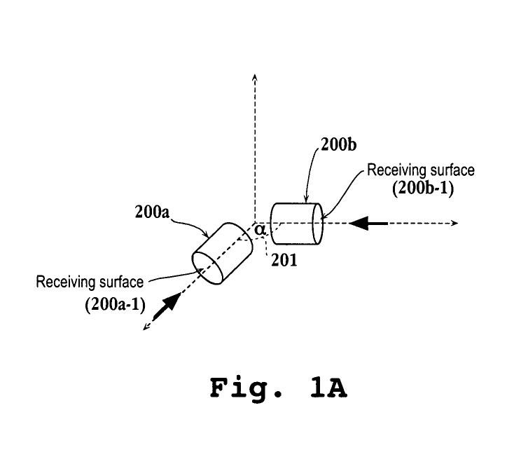

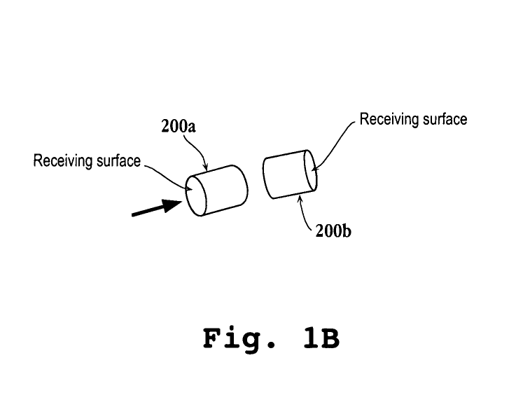

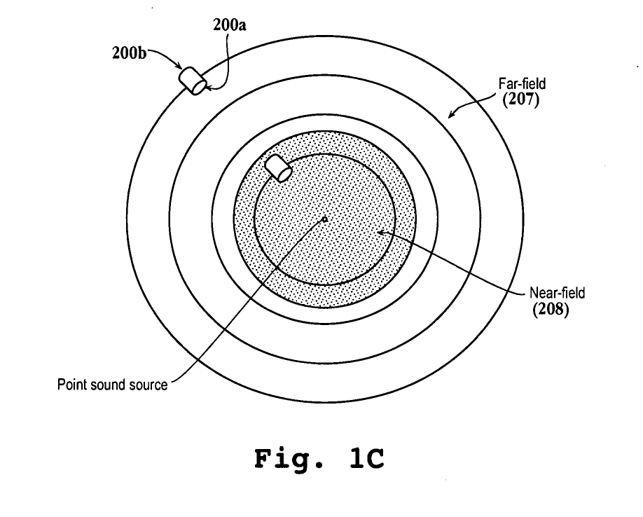

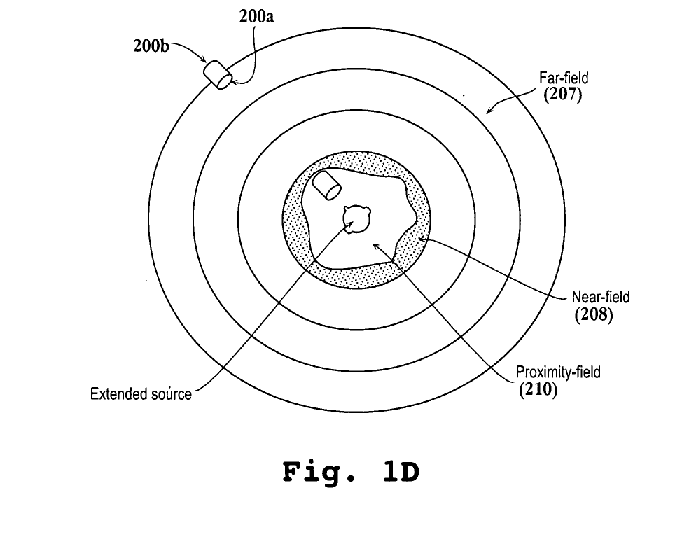

FIG. 1A is a simplified schematic diagram illustrating a possible placement of microphones where the receiving surfaces of the two microphones make an angle that is other than zero in accordance with one embodiment of the invention. FIG. 1B is a simplified schematic diagram illustrating the placement of the first and the second microphones of the proximity filter in accordance with one embodiment of the invention. The first microphone's receiving surface 200a-1 faces the most preferred direction of incoming speech signal of interest. First microphone 200a and second microphone 200b are placed back-to-back as close together as possible, with their receiving surfaces 200a-1 and 200b-1 facing in opposing directions, in accordance with one embodiment of the invention. In another embodiment, the receiving surfaces are placed in a manner relative to each other where angle 201, which represents an angle between an axis of receiving surfaces 200a-1 and 200b-1, can be any angle between 0 degrees and 180 degrees. It should be appreciated that the spacing between the first microphone and the second microphone is governed by the thickness of the device on which the microphones are mounted and may be as small as tens of microns and as large as tens of millimeters. FIG. 1C shows the concept of near-field and far-field for a point source where the point source does not generate turbulence and hence does not generate a proximity-field in accordance with one embodiment of the invention. Point source 204 has associated with it near field 206 and far field 208. Microphones 200a and 200b are illustrated as being placed within far field 208 and near field 206 for exemplary purposes. It should be noted that real world sound sources, such as the human head which may be referred to as an extended source, are not point sources.

FIG. 1D is a simplified schematic diagram illustrating a near-field, far-field, and a proximity-field for an extended source in accordance with one embodiment of the invention. An extended source generates turbulence and hence exhibits proximity-field 210 in proximity to extended source 212. For example, in close proximity of the mouth of a speaker the pressure variation is turbulent. Near-field 206 shrinks for extended source 212 and might be altogether absent in one embodiment. In FIG. 1D the acoustic pressure gradient of the primary sound source between the receiving surfaces of 200a and 200b is much greater in proximity-field 210 than in near-field 206 or far-field 208. It should be appreciated that the acoustic pressure gradient of a noise source, not in the proximity-field of the microphones, between the receiving surfaces of 200a and 200b is relatively small compared to the acoustic pressure gradient within proximity field 210.

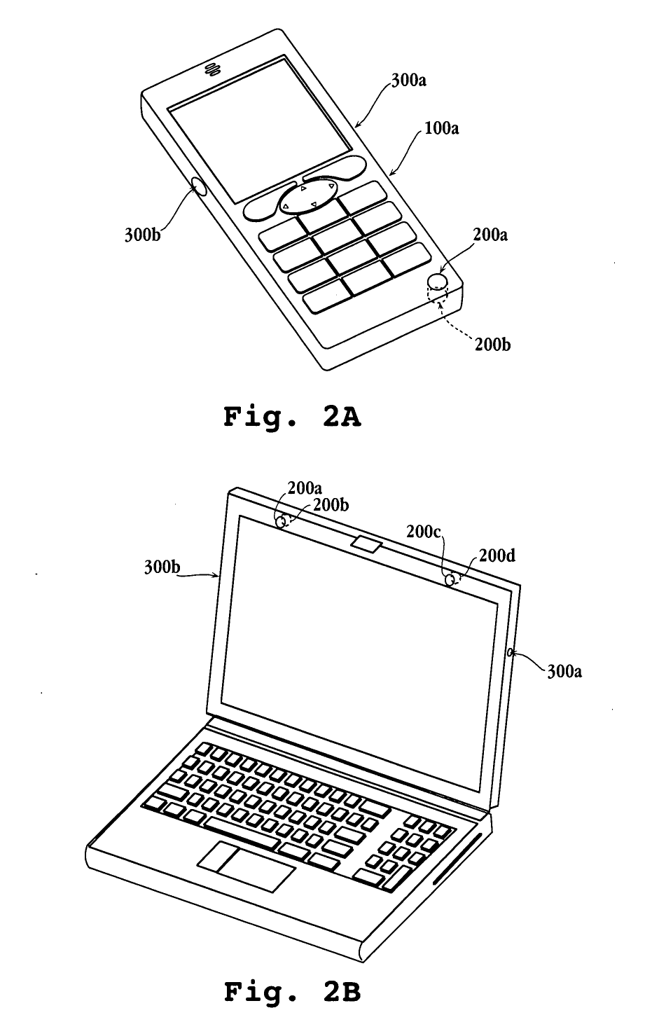

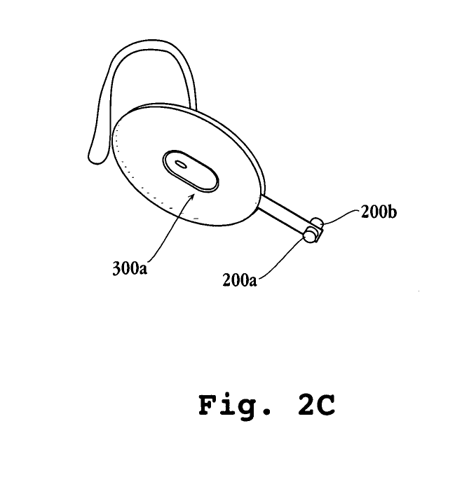

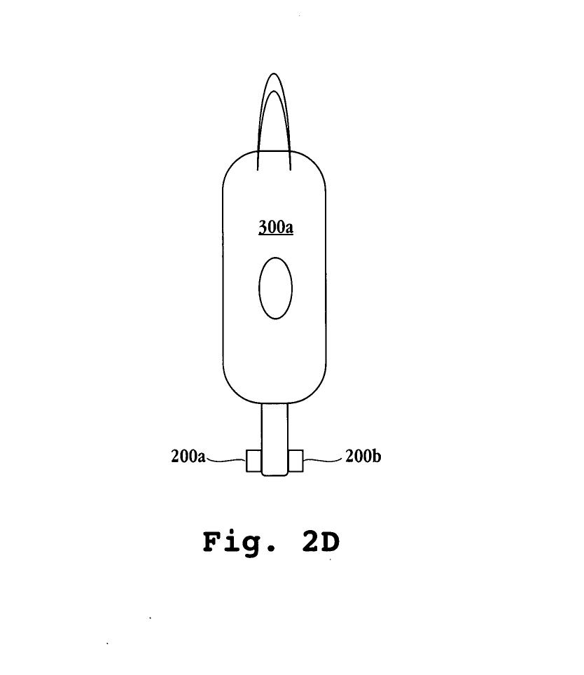

FIG. 2A is a simplified schematic diagram illustrating a mobile phone 100a having microphones 200a and 200b in back to back configuration for enhancing audio signals of a phone conversation in the proximity-field of the target speaker in accordance with one embodiment of the invention. Mobile phone 100a includes loudspeakers 300a and 300b that are positioned so that their transmitting surfaces are maximally orthogonal to the receiving surfaces of microphones 200a and 200b. Such placement of loudspeakers 300a and 300b enables cancellation of echo by the proposed proximity filter as discussed in further detail below.

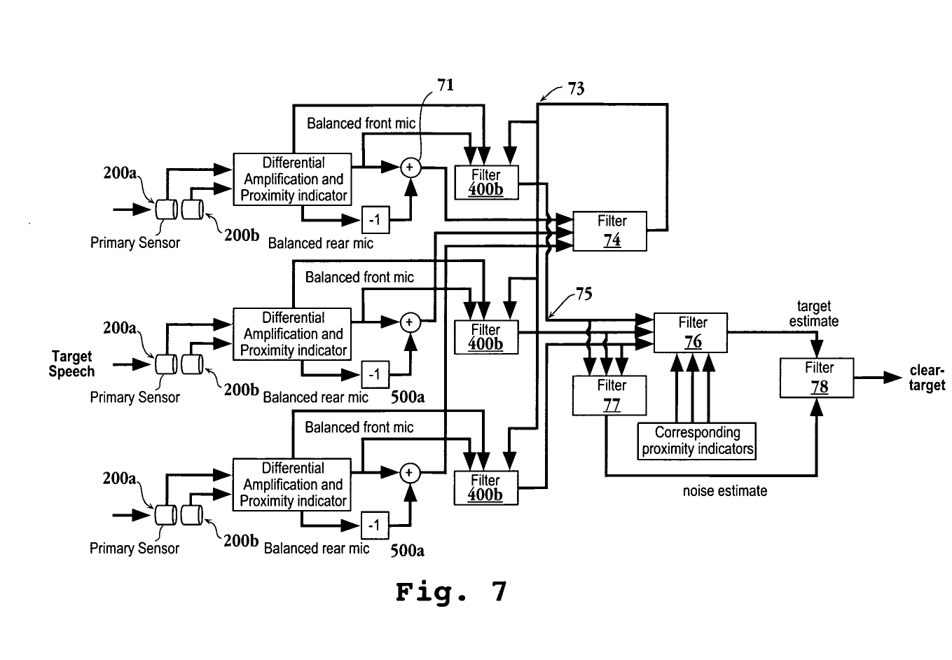

FIG. 2B is a simplified schematic diagram of a laptop having microphones 200a and 200b in back to back configuration in accordance with one embodiment of the invention. Laptop 100b includes loudspeakers 300a and 300b that are placed in such a way so that their transmitting surfaces are maximally orthogonal to the receiving surfaces of microphones 200a and 200b. Such placement of loudspeakers 300a and 300b guarantees cancellation of echo by the proposed proximity filter. Microphones 200a and 200b provide a noise corrupted audio signal to the proximity filter that generates a clean audio signal. Another embodiment of the proposed proximity filter makes use of multiple pairs (200a, 200b, and 200c, 200d) of back to back microphones as shown in FIG. 2B. Each of these pairs captures noise corrupted target signal that is processed by an embodiment of the proximity filter shown in FIG. 7 that can accept inputs from multiple pairs of back to back microphones and outputs final clear target estimate.

FIG. 2C is simplified schematic diagram of a wireless headset 100c having microphones 200a and 200b in back to back configuration in the proximity-field of the target speaker in accordance with one embodiment of the invention. Wireless headset 100c also has loudspeaker 300a placed in such a way so that a transmitting surface is maximally orthogonal to the receiving surfaces of microphones 200a and 200b. Such placement of 300a enables cancellation of echo by the proposed proximity filter. Microphones 200a and 200b provide noise corrupted audio signal to the proximity filter that generates a clean audio signal. FIG. 2D is a simplified schematic diagram illustrating a side view of the wireless headset of FIG. 2C. In one embodiment, the wireless headset is hooked to the collar or pocket of the user in the proximity field of his mouth and performs noise and echo suppression in similar fashion as the device shown in 100c.

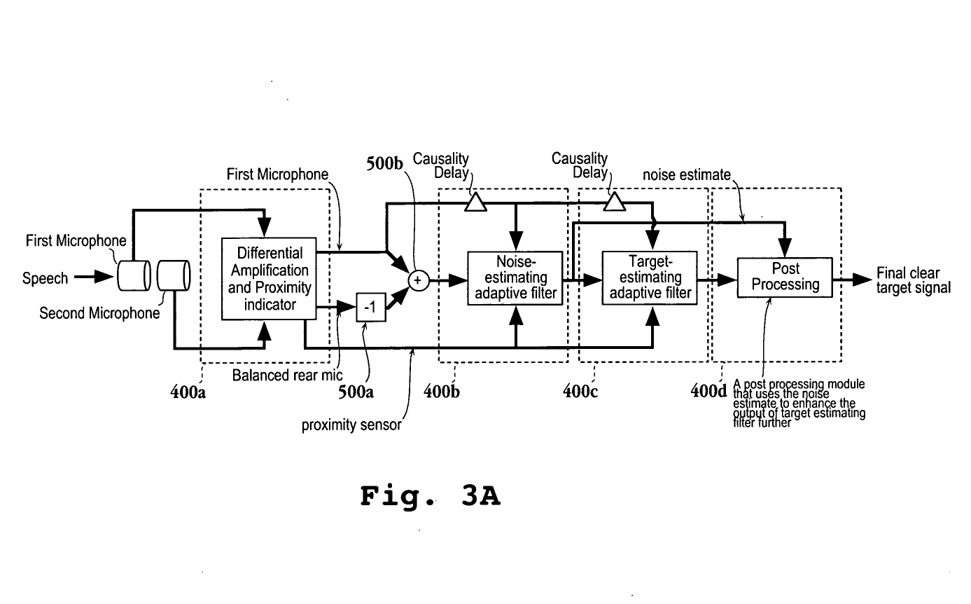

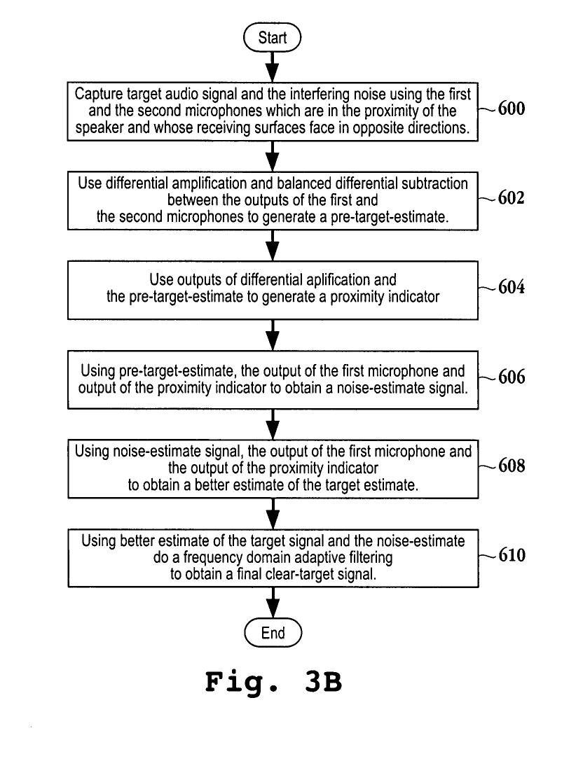

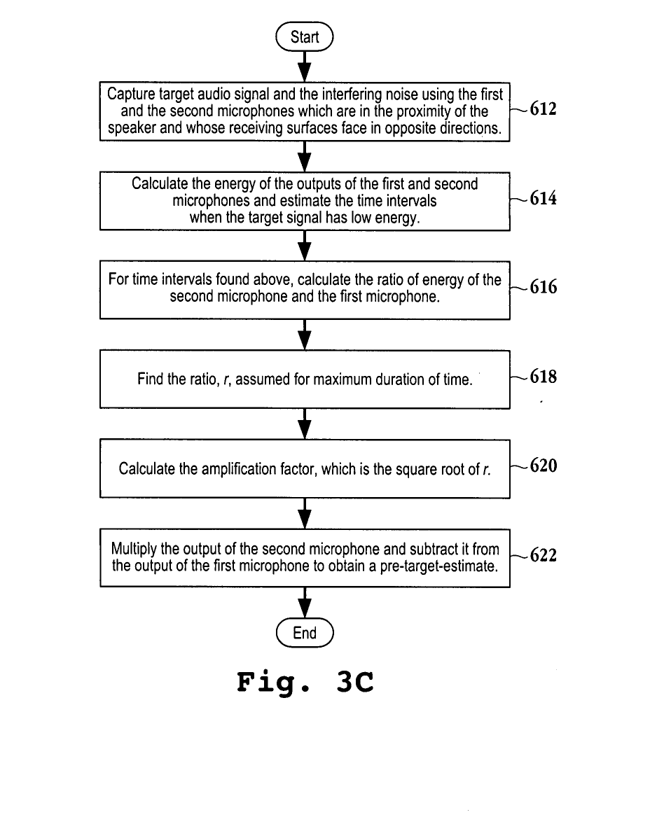

FIG. 3A is a block diagram of the components of the proximity filter capable of suppressing noise from an audio signal of interest in accordance with one embodiment of the invention. The audio signals captured from the first microphone 200a, and the second microphone 200b, are provided to differential amplification and proximity indicator block 400a. It should be appreciated that the differential amplification portion of block 400a applies differential amplification techniques to balance gains of microphones 200a and 200b as well as balanced differential subtraction between the outputs of the 200a and 200b to provide a pre-target estimate. The balanced differential subtraction is further described in more detail with reference to flowchart in FIG. 3C. The proximity indicator portion of block 400a is configured to detect an audio signal of interest that is in proximity of 200a and 200b. One skilled in the art will appreciate that the proximity indicator detects non-diffused proximity speech, i.e., the audio signal of interest, and separates the audio signal of interest from diffused noise sources that are not in proximity of the microphones. In one embodiment, the proximity indicator provides an indication of speech presence in order to facilitate speech processing, as well as possibly providing the limiters for the beginning and end of speech segment. The proximity indicator provides the percentage of the signal that is voice, i.e., proximity voice, which enables some of the adaptation techniques described herein. In another embodiment, the proximity indicator extracts some measured features or quantities from the input signal and compares these values with thresholds, usually extracted from the characteristics of the noise and speech signals.

The output from differential amplification and proximity indicator block 400a is then provided to noise estimating adaptive filter 400b and target estimating adaptive filter 400c. More specifically, the balanced rear microphone signal, which is the balanced output of microphone 200b, is inverted in block 500a and this inverted signal is added to the output of microphone 200a, the first microphone output, in block 500b. The output of first microphone 200a is also provided to adaptive filers 400b and 400c along with the proximity indicator signal. One skilled in the art will appreciate that adaptive filters 400b and 400c are used to remove background noise from the target signal which in one embodiment is speech. In another embodiment, the adaptive filters perform adaptive noise cancellation in the time domain. Typically, adaptive noise cancellation algorithms pass a corrupted signal through a filter that tends to suppress the noise, while leaving the signal unchanged. Thus, two inputs into each of adaptive filter 400b and 400c are provided. One input into each of adaptive filter 400b and 400c is the signal corrupted by noise, and the other input contains noise correlated to the noise in the first input, but not correlated to the audio signal of interest. It should be appreciated that the filter readjusts itself continuously to minimize error, thus, the adaptive label. This adjustment is assisted by providing a third input, the proximity indicator signal, to each of the adaptive filters 400b and 400c. Accordingly, based on a certain percentage of the proximity voice in the signal, as indicated by the proximity indicator signal, the processing is adjusted. For example, one aspect of the adaptive nature of the filters is related to the proximity indicator signal. The time interval over which the adaptive filters are adapted, as well as the speed of adaptation is governed by the proximity indicator signal. The output of the adaptive noise cancellation block 400c is provided to post-processing block 400d. Post processing block 400d processes the noise estimate input and the target estimate to provide a clean speech signal for output. The output of post-processing block 400d is the final clear target estimate provided through the proximity filtering described herein. Thus, having a first and a second microphone in a back to back configuration provides a final clear target speech signal from a source that is relatively close to the proximity filter. The embodiments described herein operate optimally when the audio signal of interest has more differential impact on the front and the rear microphones as compared to the interfering noise. This condition more or less holds as long as the user is within the proximity field of the microphones. Exemplary devices that the microphones may be attached to include a cell phone, a pocket personal computer, a web tablet, a laptop, a video game console, a digital voice recorder, and any other hand-held device in which voice related applications may be integrated therein.

FIG. 3B is a flow chart diagram illustrating the method operations for proximity filtering to provide a relatively noise-free and enhanced signal from an audio source within a noisy environment in accordance with one embodiment of the invention. The method initiates with operation 600 where an audio signal of interest is captured along with interfering noise using the first and the second microphones in a back to back configuration. In one embodiment, the back to back configuration includes the receiving surfaces being angled relative to each other rather than directly opposing each other. Exemplary configurations for the first and the second microphones are provided in FIGS. 1A, 1B, and 2A-2D. The user is in proximity to a device having the microphone configuration described herein, and the user's voice, i.e., the source, is captured by the receiving surfaces of the microphones. One skilled in the art will appreciate that the microphones may be any commercially available microphones, such as, micro electro-mechanical system (MEMS) type microphones, electret microphones, etc. In one embodiment, the MEMS microphones are disposed on the same substrate or package. The method then proceeds to operation 602 where differential amplification and balanced differential subtraction are utilized between the outputs of the first and the second microphones to produce a pre-target estimate, which may be referred to as a good audio estimate. It should be noted that the differential amplification and balanced differential subtraction take place in the differential amplification and proximity indicator block 400a of FIG. 3A.

The method of FIG. 3B then advances to operation 604 where the balanced first and balanced second microphone outputs are used to create a proximity indicator signal to detect the audio signal of interest. The proximity indicator signal provides a measure of the proximity of the target speaker from the first and the second microphones. Here again, the processing takes place in block 400a of FIG. 3A. The method of FIG. 3B then moves to operation 606, where the pre-target estimate provided from operation 602 and the output of the first microphone, as well as the output of the proximity indicator are processed by an adaptive filter, e.g., the adaptive filter in block 400b of FIG. 3A, are combined to obtain a noise estimate. The proximity indicator signal assists the adaptive filter to adapt to the correct solution in an efficient way. The method then advances to operation 608 where the noise estimate from operation 606 and the output of the first microphone, along with the output of the proximity indicator, are combined to obtain a target estimate, which is the source signal of interest substantially free from any noise. Finally, in operation 610, the target estimate and the noise estimate are processed by the post processing block 400d in FIG. 3A to yield final clear target estimate.

FIG. 3C is a flow chart diagram illustrating further details of the balanced differential subtraction in accordance with one embodiment of the invention. The method starts with operation 612 where an audio signal of interest is captured, along with the interfering noise, using a back to back configuration of the first and second microphones in accordance with one embodiment of the invention. The method then moves to operation 614 where the energy in the outputs of the first and the second microphones are calculated. The energy output may be characterized as a function of the amplitude of the outputs of the first and the second microphones in one embodiment. From operation 614, the method advances to operation 616 where the time indices when only noise is present in the outputs of the first and the second microphones are determined. In one embodiment, suitable thresholds which are a function of energy statistics, are used to determine time indices when only noise from outside the proximity field exists in the output of each of the microphones. The method then proceeds to operation 618 where for the time indices found above in operation 616, the ratio of energy between the first and the second microphones is determined. That is, at the time indices when noise is predominantly present, the corresponding ratio of energy between the first and the second microphones is calculated. The method then advances to operation 620 where the ratio calculated in operation 618 is analyzed to determine the value of the ratio assumed the most number of times, i.e., the maximally assumed ratio, and the maximally assumed ratio is used to calculate the amplification factor. In operation 622, the value of the amplification factor from operation 620 is used to amplify the output of the second microphone which is then subtracted from the output of the first microphone to obtain a pre-target estimate.

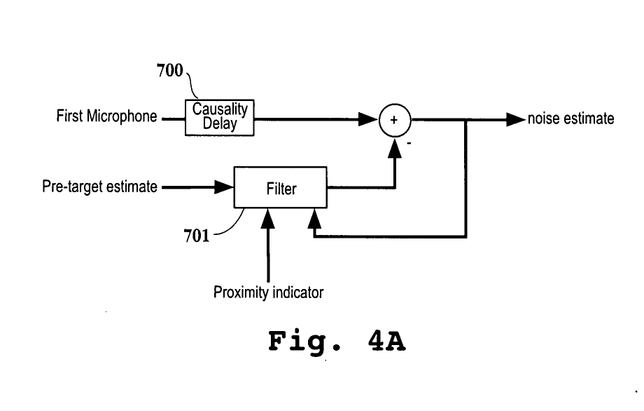

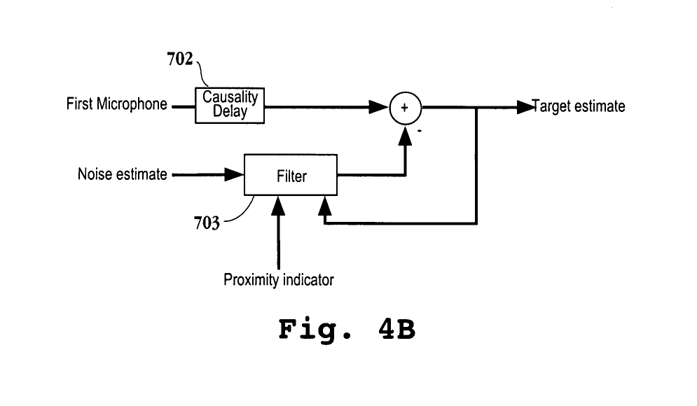

FIG. 4A is a simplified schematic diagram illustrating the noise-estimating adaptive filter in accordance with one embodiment of the invention. Causality delay 700 functions to delay the first microphone output to enable adaptive filter 701 to converge faster to the optimum solution by utilizing information ahead in time. The signal component in the output of the first microphone that is correlated with the pre-target-estimate is adaptively subtracted by the filter 701 to yield the noise-estimate.

FIG. 4B is a simplified schematic diagram illustrating the target-estimating adaptive filter in accordance with one embodiment of the invention. Causality delay 702 delays the first microphone output to enable adaptive filter 703 to converge faster to the optimum solution by utilizing information ahead in time. The noise component in the output of the first microphone that is correlated with the noise-estimate is adaptively subtracted by the filter 703 to yield the target-estimate.

FIG. 4C is a simplified schematic diagram of the post-processing block in FIG. 3A in accordance with one embodiment of the invention. Blocks 704a and 704b calculate the Fast Fourier Transform of the target-estimate and the noise-estimate, respectively. The outputs of 704a and 704b are fed to block 705 that adaptively remove the remaining noise from the target-estimate, in the frequency domain, to yield the final clean target-estimate. Block 707 transforms the final clean target-estimate into the time domain. Block 706 takes the outputs of blocks 704a, 704b and 707 to adaptively select a smoothing parameter that helps the adaptive filtering in block 705.

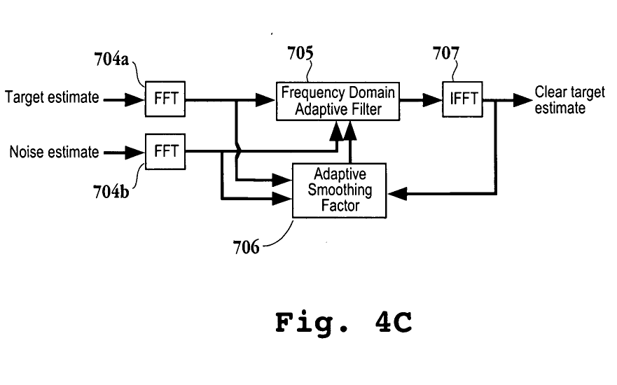

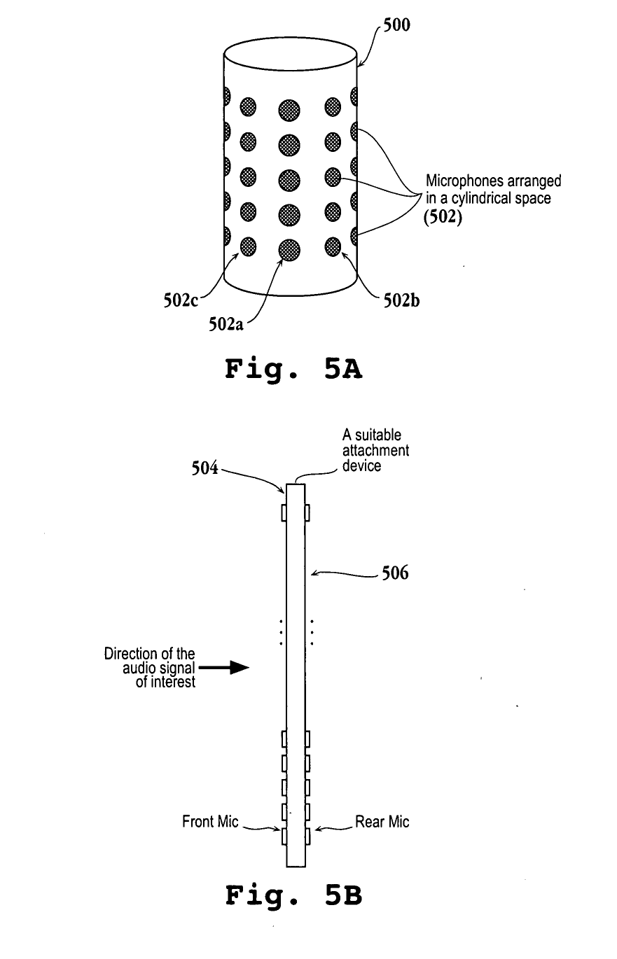

FIG. 5A is a simplified schematic diagram of a proximity filter having a cylindrical shape in accordance with one embodiment of the invention. Proximity filter 500 has a plurality of microphones 502 disposed over the cylindrical surface. As illustrated, microphones 502 are spatially arranged as columns of five microphones disposed along the cylindrical surface. It should be noted that the embodiments are not limited to this configuration. That is, any configuration may be utilized where pairs of microphones are diametrically opposed to each other to achieve the processing through the proximity filter described above. FIG. 5B is a simplified schematic diagram of multiple proximity filters where pairs of microphones are diametrically opposed to each other in accordance with one embodiment of the invention. In this embodiment, microphones are disposed at top surface 504 and bottom surface 506 in the back to back manner. It should be appreciated that the arrangement of FIG. 5A enables efficient capture of a source within a range of the perimeter of the cylindrical surface of proximity filter 500. Thus, the cylindrical configuration allows for improved spatial resolution as the microphones are disposed on a cylindrical surface rather than a planar surface. In addition, proximity filter 500 can obtain multiple noise estimates to be used to further enhance a voice signal. For example, a signal is captured through the microphones of column 502a and corresponding opposing column (not shown). This signal may be enhanced through the processing described above with respect to FIG. 3A. In addition, signals that are captured through the microphones of columns 502b and 502c may be used to provide noise estimates to further enhance the processing and achieve a better voice signal.

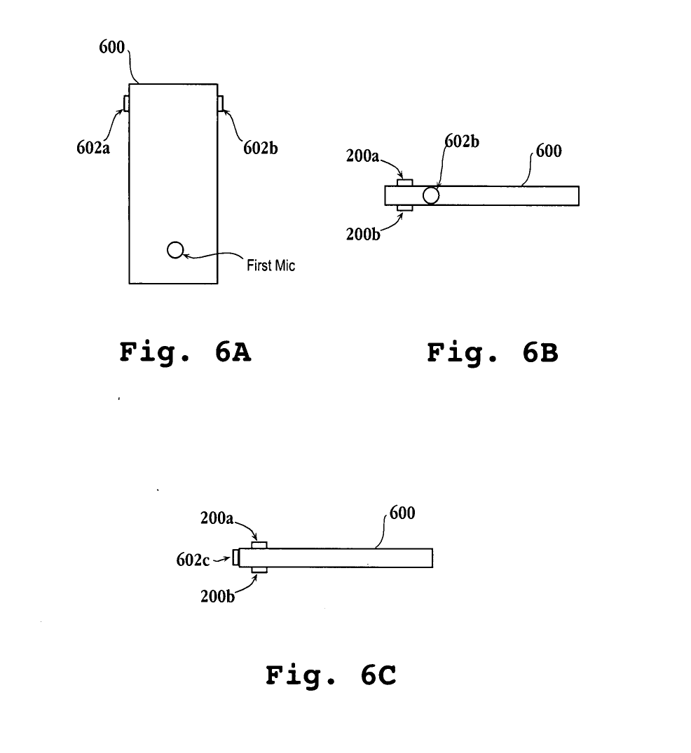

FIGS. 6A-6C illustrate proximity filter configurations including equidistant loud speaker placement in accordance with one embodiment of the invention. In FIG. 6A, attachment device 600 has a front microphone attached to a top surface of the attachment device. Speakers 602a and 602b are attached to opposing side surfaces. The placement of speakers 602a and 602b are such that the speakers are equidistant from each microphone of microphone pair in the back-to-back configuration. By placing speakers 602a and 602b in an equidistant/symmetrical manner, acoustic echo cancellation is provided through this placement configuration. For example, if the attachment device is a cell phone, the structure of FIGS. 6A-C provides for acoustic echo cancellation for operating the cell phone in full duplex mode. It should be noted that the attachment device described herein may be any of the above mentioned portable devices shown in FIGS. 2A through 2D.

FIG. 6B illustrates a side view of the microphone and speaker arrangement of FIG. 6A. It should be appreciated that speakers 602a and 602b can be placed anywhere along the corresponding side surface of attachment device 600 as long as speakers 602a and 602b are equidistantly placed and symmetrically located relative to microphones 200a and 200b. One way of describing the configuration of FIGS. 6A-6C is that microphones 200a and 200b share a planar axis and speakers 602a and 602b share a planar axis that is orthogonal to the planar axis of microphones 200a and 200b. FIG. 6C illustrates an alternative embodiment to the speaker configuration of FIGS. 6A and 6B. In FIG. 6C, a single speaker is symmetrically placed relative to microphones 200a and 200b. While speaker 602c is disposed on a different side of device 600 than the speakers of FIGS. 6A and 6B, the speaker is equidistant to each of the microphones. In addition, an axis of speaker 602c is orthogonal to an axis shared by microphones 200a and 200b. Thus, the output of the speakers of FIGS. 6A-C, which have equal impact on each of the corresponding microphones, delivers noise to the microphones. This noise can then be filtered out or cancelled through the processing described above with reference to FIG. 3A.

FIG. 7 is a simplified schematic diagram illustrating the data flow path that uses plurality of pairs of the first 200a and the second 200b microphones in accordance with one embodiment of the invention. One of the first microphones from the plurality of pairs, e.g., one which is closest to the target signal, is designated as the primary sensor of the constituent device. The outputs microphones of 200a and 200b in each of multiple pairs are processed by differential amplification and proximity indicator block to generate a localized pre-target estimate 71 for each pair. Each of the localized pre-target estimates is array processed to generate a pre-target estimate 73. The array processor 74 may be a broadside beamformer, an endfire beamformer or an independent component analysis unit in exemplary embodiments. The pre-target estimate 73 and the balanced output of the first microphone 200a from each pair are passed through an adaptive filter 400b to generate the localized noise estimate 75 as perceived by each pair of microphones. The plurality of localized noise estimates are passed as reference to the adaptive filter 76 whose primary signal is the output of the primary sensor. The output of adaptive filter 76 is a target estimate. The plurality of noise estimates are also array processed by an array processor 77 to yield a noise estimate. Finally, the target estimate and the noise estimate are processed by a frequency domain adaptive filter 78 to yield a clear target estimate.

The embodiments described herein may make use of the Flow Logic Array semiconductor technology described in commonly owned U.S. patent application Ser. Nos. 11/426,887, 11/426,882, and 11/426,880, which are hereby incorporated by reference for all purposes. That is, the processing techniques defined in these references may be used to generate the processing logic described herein, in one embodiment.

Any of the operations described herein that form part of the invention are useful machine operations. The invention also relates to a device or an apparatus for performing these operations. The apparatus can be specially constructed for the required purpose, or the apparatus can be a general-purpose computer selectively activated, implemented, or configured by a computer program stored in the computer. In particular, various general-purpose machines can be used with computer programs written in accordance with the teachings herein, or it may be more convenient to construct a more specialized apparatus to perform the required operations.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims. It should be appreciated that exemplary claims are provided below and these claims are not meant to be limiting for future applications claiming priority from this application. The exemplary claims are meant to be illustrative and not restrictive.

What is claimed is:

1. A device for enhancing a target audio signal originating proximate to the device, comprising:
a first microphone;
a second microphone, the first and the second microphones having receiving surfaces facing different directions, the device configured to enhance the target audio signal by sensing an acoustic pressure gradient across the first microphone and the second microphone, the device further configured to suppress an undesired noise signal not originating in a proximity of the device.

2. The device of claim 1, where a surface of the first microphone is placed at a distance from the second microphone, where the distance is independent of a wavelength of an audio wave received by one of the first microphone or the second microphone.

3. The device of claim 2, wherein the distance is less than 100 microns.

4. The device of claim 2, wherein the distance is less than 10 millimeters.

5. The device of claim 1, wherein the target signal originates within 50 centimeters of the device.

6. The device of claim 1, wherein the target signal originates within 5 feet of the device.

7. The device of claim 1, wherein the receiving surface of the first microphone faces in an opposite direction to the receiving surface of the second microphone and wherein the receiving surface of the first microphone faces a direction from which the target signal originates.

8. The device of claim 1, further comprising:
a loudspeaker having a transmitting surface orthogonally positioned relative to the receiving surfaces of the first microphone and the second microphone such that the loudspeaker is configured to cause a minimal acoustic pressure gradient across the receiving surfaces of the first and second microphones thereby enabling the device to suppress an audio signal originated by the loudspeaker.

9. The device of claim 1, wherein the first microphone and the second microphone are one of micro-electro-mechanical system (MEMS) type microphones or electret type microphones.

10. The device of claim 1, wherein the first microphone, the second microphone and signal processing logic for processing signals received by the first and second microphones are fabricated on a same substrate, and wherein the substrate is packaged with acoustic inlets corresponding to each microphone, the acoustic inlets facing opposite directions.

11. The device of claim 1, further comprising:
signal processing logic configured to generate a proximity-indicator signal through a combination of outputs of the first microphone and the second microphone, wherein the proximity-indicator signal indicates a strength of the target signal as compared to a strength of a noise signal.

12. The device of claim 11, wherein the signal processing logic generates a pre-target-estimate signal by combining the outputs of the first microphone and the second microphone, the pre-target-estimate signal representing a preliminary estimate of the target audio signal.

13. The device of claim 12, wherein the signal processing logic generates a noise-estimate signal by combining the output of the first microphone, the proximity-indicator signal and the pre-target-estimate signal.

14. The device of claim 13, wherein the signal processing logic generates an audio-estimate signal by combining the output of the first microphone, the proximity-indicator signal, and the noise-estimate signal, the audio estimate signal improving the pre-target estimate signal.

15. The device of claim 14, wherein the signal processing logic generates a clear-target signal by combining the proximity-indicator signal, the audio estimate signal and the noise-estimate signal, the clear-target signal enhancing the target audio signal while suppressing the noise signal.

16. The device of claim 12, wherein the device selectively enhances audio signals originating from a desired sub-region proximate to the device, the device further including,
a plurality of signal processing logic modules associated with corresponding microphone pairs, each signal processing logic module generating a corresponding pre-target estimate signal;
a designated primary microphone pair selected from one of the microphone pairs wherein one of the microphones of the designated primary microphone pair is closest to the target audio signal; and
a designated primary-proximity-indicator corresponding to the designated primary microphone pair.

17. The device of claim 16, wherein the pre-target-estimate signal is generated by combining corresponding pre-target-estimate signals, the pre-target-estimate signal providing a preliminary estimate of the target audio signal.

18. The device of claim 17, further comprising signal processing logic configured to generate a plurality of noise-estimate signals by combining the pre-target-estimate signals with corresponding output of respective microphones and proximity-indicators.

19. The device of claim 18, further comprising signal processing logic configured to generate a target-estimate signal by combining output of the designated primary microphone with a plurality of proximity-indicator signals and the corresponding noise-estimate signals.

20. The device of claim 19, further comprising signal processing logic configured to generate a noise-estimate signal by combining the plurality of proximity-indicator signals and corresponding noise-estimate signals.

21. The device in claim 20, further comprising signal processing logic configured to generate a final clear-target signal by combining the target-estimate signal, the noise-estimate signal and the primary-proximity-indicator signal.

22. The device in claim 1, wherein the device is integrated into a device selected from a group consisting of a wireless device, a portable device, a display device, and an audio visual device.

23. The device in claim 22, wherein the portable device is one of a mobile phone or a media player.

24. A method for enhancing a target audio signal portion of an audio signal where the target audio signal portion originates proximate to the device, comprising:
measuring an acoustic pressure gradient across a first sensor and a second sensor;
identifying the target signal portion based on the acoustic pressure gradient across the first and second sensors; and
identifying noise within the audio signal based on the acoustic pressure gradient across the first and second sensors, the acoustic pressure gradient across the first and second sensors for the noise is diminished relative to the acoustic pressure gradient across the first and second sensors for the target signal portion.

25. The method of claim 24, further comprising:
minimizing the acoustic pressure gradient across the first and second sensors for the noise by reducing a distance between the first and second sensors.

26. The method of claim 24, further comprising:
maximizing the acoustic pressure gradient across the first and second sensors for the target signal portion by maximizing an orthogonality of sensing directions for the first and second sensors.

27. The method of claim 24, further comprising:
orienting the first sensor in a direction of the target signal portion.

28. The method of claim 24, further comprising:
orienting a transducer in proximity the first sensor and the second sensor to cause minimal pressure gradient across the first sensor and the second sensor, thereby suppressing an audio signal originated by the transducer.

29. The method of claim 24, further comprising:
measuring strength of the target signal portion relative to a noise signal through a function of differential-mode energy and common-mode energy between the first sensor and the second sensor.

30. The method of claim 29, further comprising:
pre-processing output of the second sensor through an adaptive gain control function; and
determining a pre-target-estimate representing a difference between output of the first sensor and the pre-processed output of the second sensor.

31. The method of claim 30, further comprising:
adaptively filtering out the pre-target-estimate from output of the first sensor to measure a noise-estimate, wherein a rate of adaptation is governed by a proximity-indicator.

32. The method of claim 31, further comprising:
measuring a target audio estimate providing an estimate of the target audio signal by adaptively filtering the noise-estimate from the output of the first sensor, wherein a rate of adaptation is governed by the proximity-indicator.

33. The method of claim 32, further comprising:
generating a final clear-target audio signal that enhances the target audio signal and suppresses the noise signal by adaptive filtering of the noise-estimate from the target audio estimate, wherein the rate of adaptation of the adaptive filtering process is smoothed using the proximity-indicator.

34. The method of claim 33, wherein the adaptive filtering is Wiener adaptive filtering utilizing a smoothing factor, the smoothing factor estimated by measuring spectral change between the target audio estimate and the noise-estimate.

35. The method of claim 30, wherein the targeted audio signal originates from a targeted sub-region in proximity of the device by designating one of a plurality of sensor pairs as a sensor pair closest to the target audio signal, one of the sensors of the sensor pair designated as the first sensor.

36. The method of claim 35, further comprising:
generating a pre-target-estimate by array processing a plurality of pre-target-estimates from each of the plurality of sensor pairs.

37. The method of claim 36, wherein the array-processing is one of broad-side beam-forming or end-fire beam-forming.

38. The method of claim 36, wherein the array-processing includes independent component analysis (ICA).

39. The method of claim 36, further comprising:
generating an array of noise-estimates by adaptive filtering of corresponding pre-target-estimates from corresponding outputs of respective first sensors, wherein a rate of adaptation is governed by corresponding proximity-indicators.

40. The method of claim 39, further comprising:
generating a target-estimate by a plurality of adaptive filtering operations to filter corresponding noise-estimates from the output of the first sensor, wherein the rate of adaptation is governed by the corresponding proximity-indicators.

41. The method of claim 40, further comprising:
generating a noise-estimate by the array processing utilized for the plurality of pre-target-estimates.

42. The method of claim 41, further comprising:
generating a final clear-target by adaptive Weiner filtering of the noise-estimate from the target-estimate.
